(19) United States
(12) Patent Application Publication
(10) Pub. No.: US 2007/0215449 A1
(43) Pub. Date: Sep. 20, 2007

(54) Fan/light distinguishing pull chains

(76) Inventor: Christopher A. Peone, Tillson, NY (US)

Correspondence Address: Christopher A. Peone, 42 Messmer Ave., Tillson, NY, 12486, US

(21) Appl. No.: 11/337,035

(22) Filed: Mar. 15, 2006

(51) Int. Cl. H01H 3/20

(52) U.S. Cl. 200/332

(57) ABSTRACT

What I believe makes these Pull chain ornaments unique from others currently on the market is their shape which resembles that of the overhead fan and light. These pull chain ornaments once attached allow the user to differentiate the existing pull chains light and fan on/off switches. Taking the guess work out and becoming a Universal language, even in total darkness.

### CROSS REFERENCE TO RELATED APPLICATIONS

Application Ser. No. 11/337,035 Dated Jan. 23, 2006

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

I am applying for a Non-Provisional Utility Patent as this invention is a functional & decorative improvement to an existing product. The current pull-chain ornaments in today's market Do Not clearly help the user to distinguish between the fan & light pull chain on/off switches. This invention eliminates the guess work Reference Disclosure Document # 568799 Dated Jan. 24, 2005

### BRIEF SUMMARY OF THE INVENTION

The idea of this invention is to always pull the correct chain when attempting to turn on or off the overhead fan or light. The advantage of this invention is the inventions resemblance to the actual fan & Light allow operation in total darkness, this item is a universal language.

### BRIEF DESCRIPTION OF SEVERAL VIEWS

Reference Description of Component & Figure Numbers Reference Sheets enclosed for both the Fan & Light Distinguishing Pull-Chains

### DETAILED DESCRIPTION OF THE INVENTION

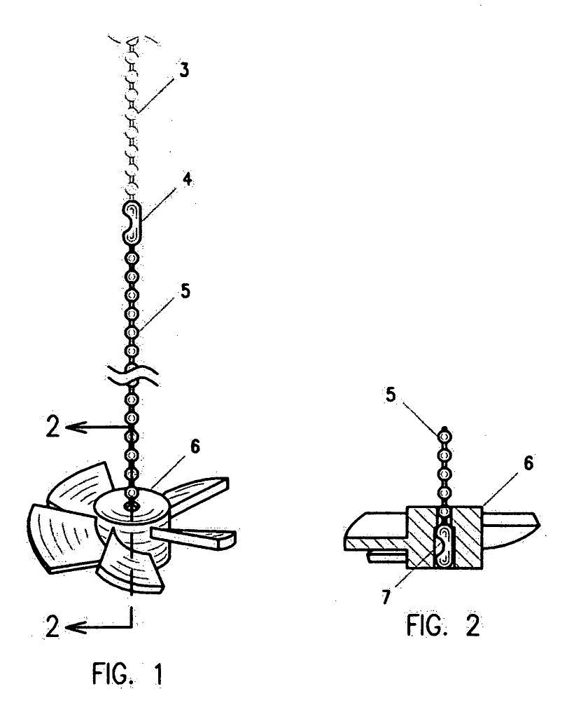

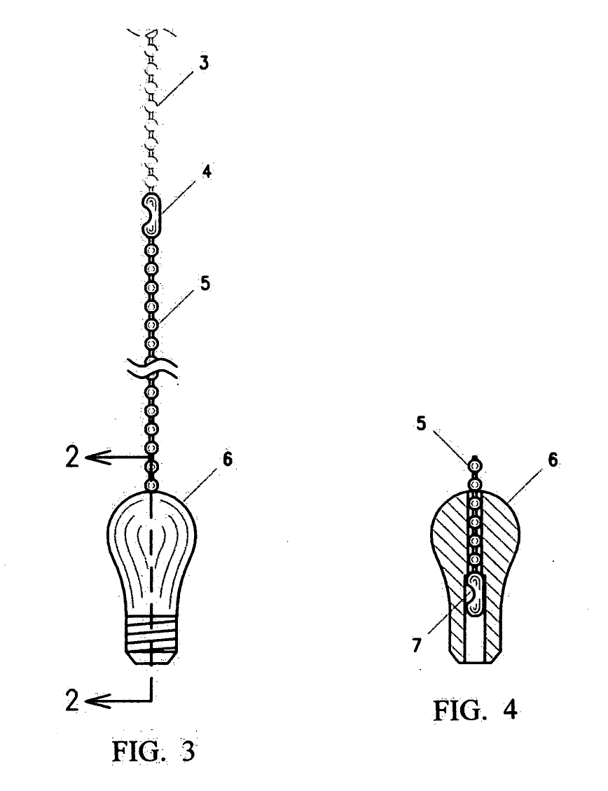

This invention consists of 2 injection molded Pull-Chain ornaments FIG. 1 & FIG. 3 Views, (component #6) on the part drawings enclosed. A 2 cavity injection mold will be used, producing one each of the pull-chain ornaments, yielding one set of ornaments per cycle. Once molded in High Density Polyethylene the ornaments will need to be center drilled and counter bored thru vertically. The counter bored hole needs to be large enough for the bottom connecting link (component #7) to nest up inside the ornament and not fit through the smaller hole. The smaller thru hole is just slightly larger than the beaded chain outside diameter.(components #3 & #5) allowing for the chain to pass through and not allowing the connecting link to pass through. The top connecting link (component #4) then connects to the appropriate existing fan or light pull-chain (component #3). In the event the existing fan or light pull-chains (component #3) are long enough and has its own connecting link, then (components 4, 5 & 7) will not be required and the ornaments will connect directly to the existing pull-chains (component #3) The ornament color finishes are achieve by adding the correct color and percentage of color concentrate to the natural High Density Polyethylene resin during the injection molding process. These color finishes match the most common existing fan & light combinations (polished brass, antique brass, brushed nickel, black & white) The ornaments themselves are the invention not the chain or connecting links and are sold as a set for Distinguishing the difference between the existing fan and light pull chains furnished with the fixture (component #3)

1. Although the Title is “Fan/Light Distinguishing Pull Chains” and the drawings show beaded chain and connecting links, the actual invention is the injection molded Fan/Light pull chain ornaments which attach to the ends of those chains.

2. FIG. 1 & FIG. 3 Views (component #6) found on the part drawings are the Fan/Light ornaments, which are to be injection molded in the shape of a fan & light and provide an accurate means of distinguishing the light & fan pull chains.
